(19) United States
(12) Patent Application Publication
(10) Pub. No.: US 2013/0079999 A1
(43) Pub. Date: Mar. 28, 2013

(54) Rotor/Engine Speed Control for Cold Planer

(71) Applicants: Daniel H. Killion, Blaine, MN (US); Andrew J. Krolnik, Brooklyn Park, MN (US); Craig M. Steffen, Maple Grove, MN (US)

(72) Inventors: Daniel H. Killion, Blaine, MN (US); Andrew J. Krolnik, Brooklyn Park, MN (US); Craig M. Steffen, Maple Grove, MN (US)

(73) Assignee: CATERPILLAR PAVING PRODUCTS INC., Minneapolis, MN (US)

(21) Appl. No.: 13/247,052

(22) Filed: Sep. 28, 2011

(51) Int. Cl. G06F 17/00

(52) U.S. Cl. 701/50

(57) ABSTRACT

Cold planers work in a variety of conditions where different rotor speeds can be beneficial. The rotor is connected directly to the engine via a clutch so the speed cannot be changed independent of the engine speed. The control system disclosed herein enables the operator to quickly select from a plurality of different engine/rotor speeds. The engine/rotor speeds correspond to different machine applications. Each speed corresponds to a point on the torque map for the particular cold planer that will offer acceptable machine performance for the particular application. If the operator inputs one of the plurality of different commands, a timer is activated and movement of the cold planer must take place within a predetermined time period or the engine speed is reduced to the elevated idle speed where the clutch is able to engage the rotor.

### TECHNICAL FIELD

This disclosure relates generally to a system and method for controlling the engine and rotor speeds of cold planers for optimizing performance and fuel efficiency.

### BACKGROUND

Cold planers, also known as pavement profilers, road milling machines or roadway planers, are machines designed for scarifying, removing, mixing or reclaiming material from the surface of bituminous or concrete roadways and similar surfaces. Cold planers typically have a plurality of tracks or wheels which adjustably support and horizontally transport the machine along the surface of the road to be planed. Cold planers also have a rotatable planing rotor or cutter that may be mechanically or hydraulically driven. Vertical adjustment of a cold planer with respect to the road surface may be provided by hydraulically adjustable rods that support the cold planer above its tracks or wheels.

While the rotor may be driven hydraulically, such hydraulically powered motor systems are typically less efficient at transmitting power to the rotor than mechanical drive arrangements which directly connect the rotor to the engine through a clutch. Mechanical drive arrangements are also particularly suited for mounting the rotor directly on the frame of the cold planer. Mounting of the rotor, or more specifically the rotor bearing housings, directly on the vehicle frame provides rigidity between the rotor and the machine suspension system thereby minimizing undesirable deflection of the rotor during the surface milling or planing operation. For these reasons, it may be desirable to mount the rotor and the engine driving the rotor directly on the cold planer frame and provide a direct mechanical drive between the engine and the rotor.

This disclosure is directed to cold planers that work on a variety of conditions that may require different rotor speeds or where different rotor speeds could be beneficial. In cold planers where the rotor is connected directly to the engine via a clutch and belt system, the speed of the rotor cannot be changed independently of the engine speed.

Two problems are associated with this type of cold planer. First, frequent changing of the rotor speed and therefore the planing operation at hand, may cause substantial wear and tear on the clutch. Second, while a direct mechanical connection between the engine and rotor is more efficient, cold planers still consume large quantities of fuel, which can substantially affect operating costs.

Therefore, a control system is needed for cold planers that work on a variety of conditions thereby requiring a variety of different rotor speeds. Such a control system may be designed to help protect clutch life and/or reduced fuel consumption.

### SUMMARY OF THE DISCLOSURE

A cold planer is disclosed which includes an engine coupled to a clutch. The clutch is detachably engaged with a rotor. The engine and clutch are linked to a controller. The controller is also linked to a control console. The control console includes a plurality of operator inputs. The plurality of operator inputs includes a rotor speed control switch and a propel enable switch. The rotor speed control switch has at least an off position, an on position and a plurality of different engine speed positions. The propel enable switch sends a signal to the controller to allow the cold planar to move.

The controller is programmed to adjust the engine speed to a first speed when (1) the engine is running, (2) the rotor speed control switch is switched to the on position and (3) the clutch is not engaged with the rotor. In an embodiment, the first speed can range from about 800 to about 1100 rpm.

The controller is also programmed to send a signal to the clutch to engage the rotor when the engine reaches the first speed. The controller is also programmed to adjust the engine speed from the first speed to a second speed that is greater than or equal to the first speed when the engine is running at the first speed and after the controller has sent a signal to the clutch causing the clutch to engage the rotor. In an embodiment, the second speed may range from about 1100 rpm to about 1300 rpm.

The rotor speed control switch may be a toggle switch or similar device with two active positions. The rotor speed control switch changes what the desired setting is and an LED display above or near the switch indicates the desired setting. The engine does no elevate to the desired speed until either the propel enable switch is pressed, the machine is manually lowered or automatically lowered with the grade/slope adjustment mechanism.

And, upon activation of the propel enable switch, the timer is activated and, if a predetermined time period has elapsed without movement of the cold planer, the controller is programmed to return the engine to the second speed.

A method for controlling the speed of an engine and a rotor of a cold planer is also disclosed. The method includes providing the cold planer with an engine coupled to a clutch. The clutch is detachably engaged with a rotor. The engine and clutch are linked to a controller. The controller is also linked to a control console and a timer. The control console includes a plurality of operator inputs that include a rotor speed control switch and a propel enable switch. The rotor speed control switch has at least an off position and an on position.

The method also includes adjusting the engine speed to a first speed when the engine is running and the rotor speed control switch is switched to an on position and the clutch is not engaged with the rotor.

The method also includes engaging the rotor with the clutch when the engine reaches the first speed. The method also includes adjusting the engine speed from the first speed to a second speed after the clutch has engaged the rotor.

The method also includes adjusting the engine speed from the second speed to a third speed that is higher than the second speed when the rotor speed control switch is switched to a third speed position. And, the method also includes activating the timer upon activation of the propel enable switch and, if a predetermined time period elapses without movement of the cold planer, returning the engine speed to the second speed.

Another cold planer is disclosed which comprises an engine coupled to a clutch. The clutch is attachably engaged with a rotor. The engine and clutch are linked to a controller. The controller is also linked to a control console. The control console includes a plurality of operator inputs including a rotor speed control switch and a propel enable switch. The cold planer also includes a timer. The rotor speed control switch is a toggle switch having an off position, an on position and a neutral position. The rotor speed control switch is able to access a plurality of different engine speeds by toggling the rotor speed control switch repeatedly to the on position.

The controller is programmed to adjust the engine speed to a first speed when the engine is running and the rotor speed control switch is switched to the on position and the clutch is not engaged with the rotor. The controller is also programmed to send a signal to the clutch to engage the rotor when the engine reaches the first speed.

The controller is also programmed to adjust the engine speed from the first speed to the second speed that is higher than the first speed when the engine is running at the first speed and after the controller has sent a signal to the clutch causing the clutch to engage the rotor.

The controller is also programmed to adjust the engine speed from the second speed to a third speed that is higher than the second speed when the rotor speed control switch is toggled to the on position when the engine is running at the second speed.

The first speed is a low idle speed for engaging the clutch. The second speed is a elevated idle speed while the clutch is engaged. The third speed is a low cutting speed. The rotor speed control switch also providing access to higher cutting speeds than the third speed, such as a fourth speed and optionally, a fifth speed. Higher speeds are also possible. In an embodiment, the third speed may range from about 1500 to about 1800 rpm; the fourth speed may range from about 1650 to about 1950 rpm; and the fifth speed may range from about 1800 to about 2100 rpm.

Upon activation of one or more operator inputs selected from the group consisting of activating propel enable switch, changing a height of a cold planer above a work surface, changing a setting of a grade/slope system, stopping the cold planer and combinations thereof, the timer is activated. If a predetermined time period has elapsed without movement of the cold planer after the timer is activated, the controller is programmed to return the engine to the second speed.

### BRIEF DESCRIPTION OF THE DRAWINGS

FIG. 1 is a side view of a cold planer having a disclosed control system.

FIG. 2 schematically illustrates the communication between the controller, the control console, the rotor, clutch, engine and various sensors.

FIGS. 3-5 are flow diagrams illustrating a disclosed control scheme for reducing fuel consumption and clutch wear.

FIG. 6 is a torque map that graphically illustrates the relationship between engine speed, torque and horsepower of a cold planer.

### DETAILED DESCRIPTION

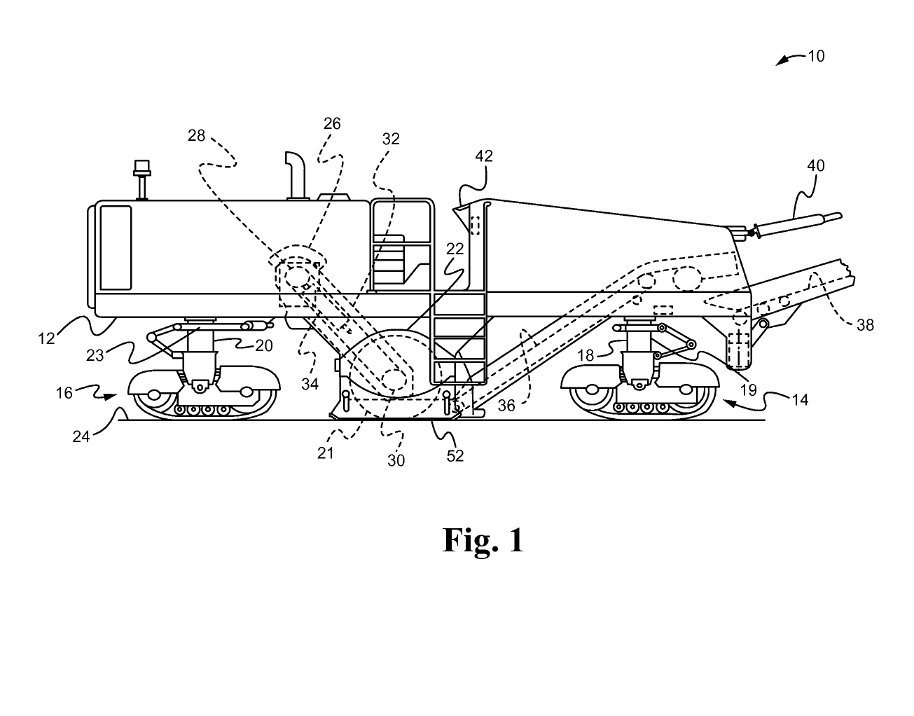

A cold planer 10 is illustrated in FIG. 1 and includes a frame 12 that is carried for movement along a road surface by a pair of front track assemblies 14 and a pair of rear track assemblies 16. The frame 12 is supported on the track assemblies 14, 16 (only two of four track assemblies are shown in FIG. 1) by hydraulically actuated adjustable struts 18, 20 that extend respectively between each of the pair of track assemblies 14, 16 and the frame 12. The hydraulic cylinders 19, 23 are used to raise and lower the cold planer 10.

A rotor 21 is rotatably mounted to the frame 12 and has a housing 22 surrounding all but the body of the rotor 21, which is necessarily exposed to the road surface 24. The depth of the cut or penetration of the cutting teeth (not shown) of the rotor 12 is controlled by appropriate extension or retraction of the adjustable struts 18, 20 and cylinders 19, 23. The cold planer 10 also includes an engine 26 as a source of power that may drive the rotor 21 via a mechanical drive arrangement that includes pulleys 28, 30, a belt 32 and a belt tensioner 34. Of course, as will be apparent to those skilled in the art, other arrangements can be employed besides the mechanical arrangement shown in FIG. 1, such as a gear train, hydraulic system or others.

The cold planer 10 also includes a pickup conveyor belt 36 which delivers debris to the discharge conveyor belt 38. The discharge conveyor belt 38 and its associated framing and pulleys (not shown) is supported by the telescoping arm 40. Finally, the cold planer 10 also includes a control console 42.

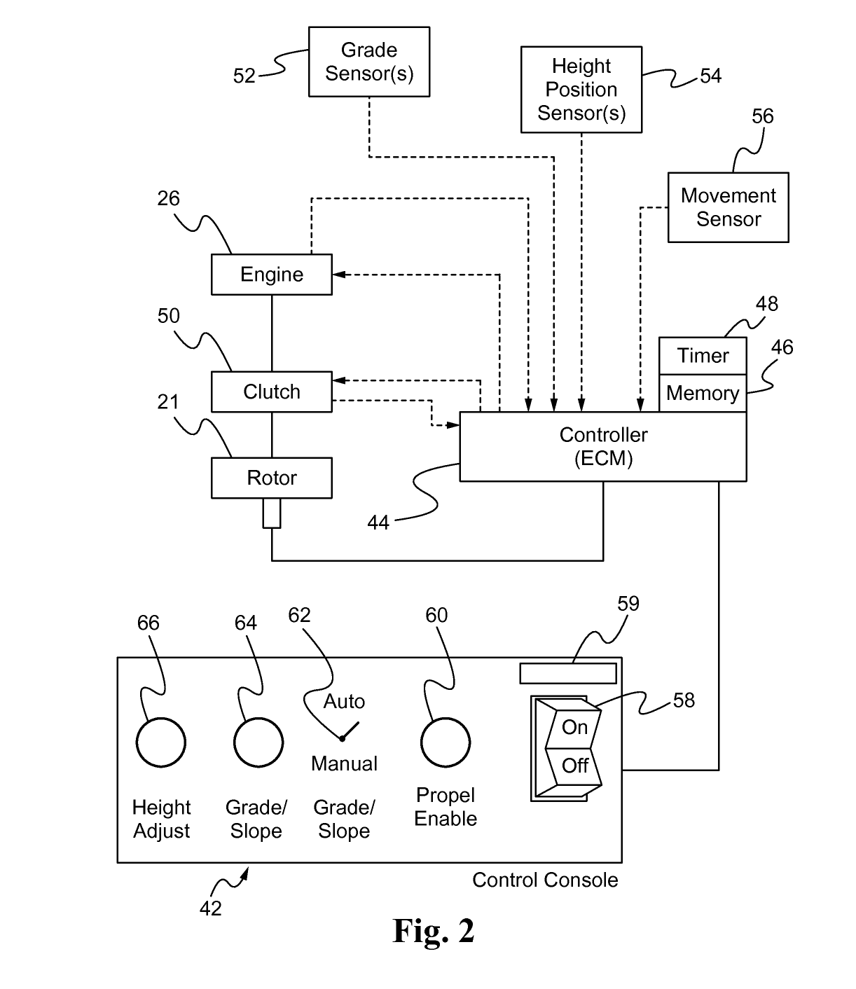

A control console 42 is partially illustrated in FIG. 2 which schematically illustrates the relationship between the controller or ECM 44 and the remaining components relevant to this disclosure. Of course, the control console 42 may also include gauges for a water pump, compressor, etc. Specifically, the controller 44 includes a memory 46 and may also include a timer 48. The controller 44 is linked to the engine 26 and, a clutch 50, which may be a hydraulically actuated clutch 50 that is coupled to the engine 26. The clutch 50 may also be detachably engaged to the rotor 21, which may also be linked to the controller 44. The controller 44 may also be linked to a variety of sensors, such as grade sensors, one of which is shown at 52 in FIG. 1, height position sensors 54, which may be linked, coupled or associated with the struts 18, 20 (see FIG. 1) and a movement sensor 56 which may be linked, coupled or associated with the front and/or rear track assemblies 14, 16 or the rotor 21.

Still referring to FIG. 2, the control console 42 may include a variety of operator inputs, such as a rotor speed control switch 58, a propel enable switch 60, a grade/slope auto/manual switch 62, a manual adjustment mechanism 64 for the grade/slope system and a height adjustment mechanism 66 for manually adjusting the struts 18, 20 and cylinders 19, 23 (see FIG. 1). The grade/slope auto/manual switch or button 62 may be disposed elsewhere, such as on a grade/slope controller (not shown), which may be disposed elsewhere on the cold planer 10 or near the top of the operator console (not shown).

The rotor speed control switch 58 may be a two position rocker or toggle switch that the operator may use to select from a plurality of different engine/rotor speeds. In one embodiment, the rotor speed control switch 58 enables the operator to choose between three different cutting speeds S3, S4 and S5 and the controller 44 will automatically cause the engine 26 to run at one of the idle speeds S1 and S2, which will be explained in detail below. The selected or desired speed is shown on the display 59, which may be an LED display or other suitable display or indicator.

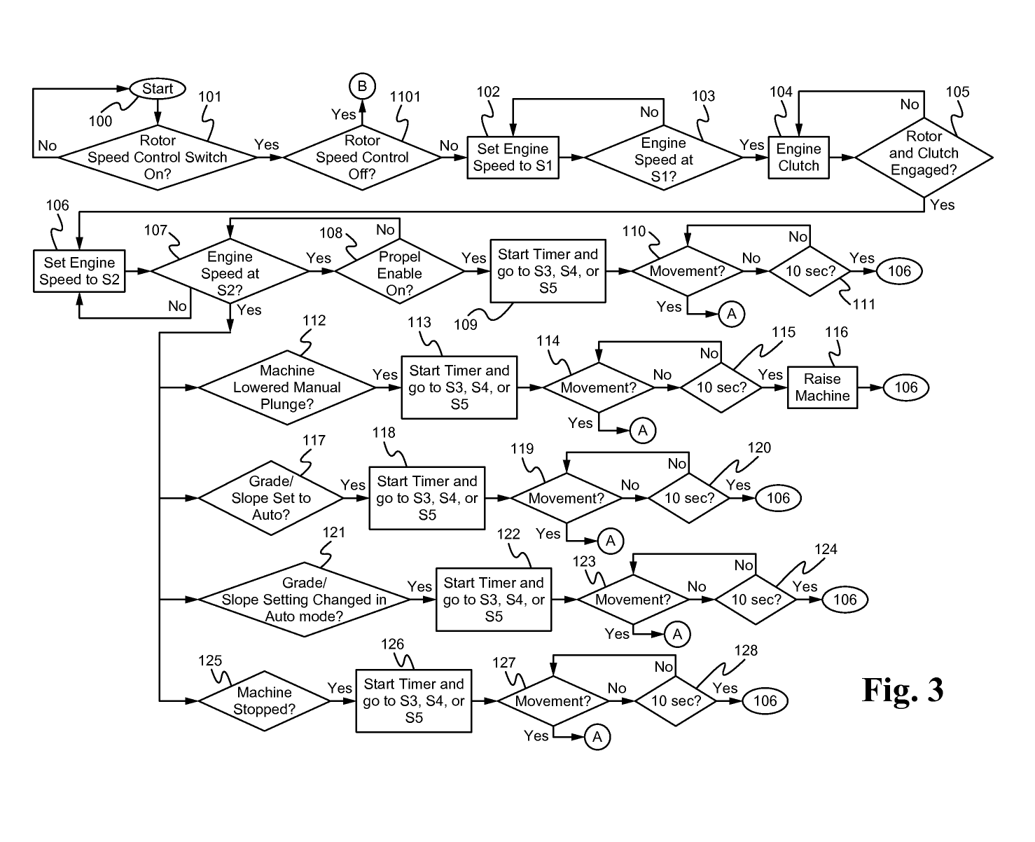

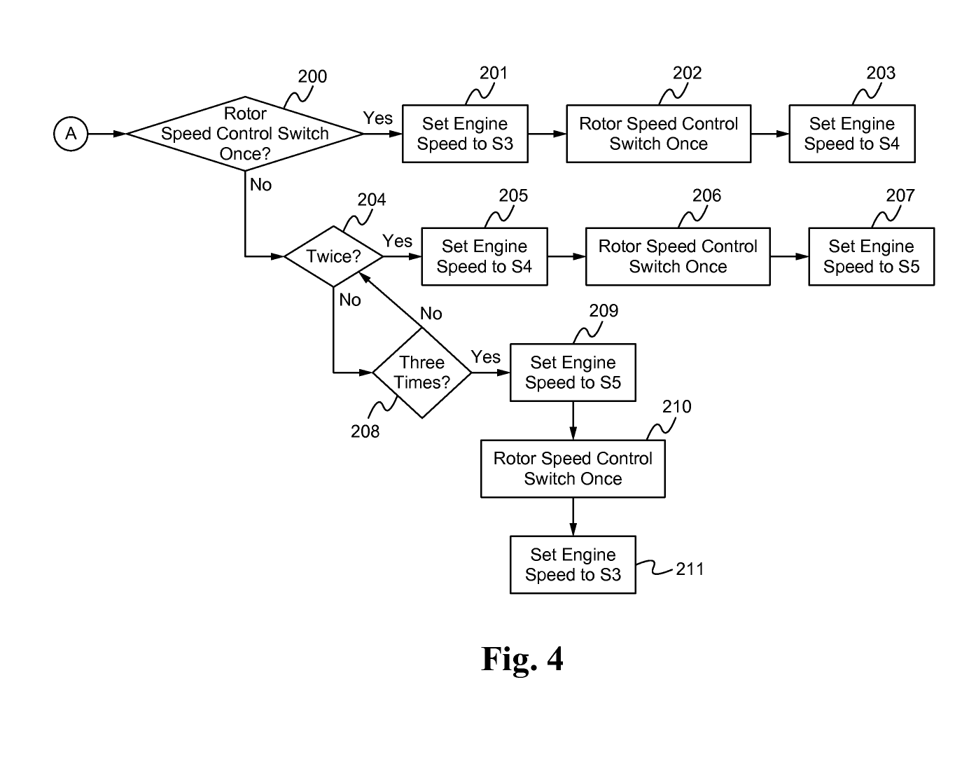

The propel enable switch 60 may be in the form of a simple push button (see FIG. 2), and includes two positions: an on position (with the button depressed); and an off position (with the button released, which may activate a timer as explained below). When the operator presses the propel enable switch 60 (or button 60), the machine may be propelled in either the forward or reverse directions. If the operator presses and releases the propel enable switch 60, he/she has a predetermined time period such as 6 or 10 seconds to initiate movement of the cold planer 10. While the predetermined time period is indicated as 10 seconds in FIGS. 3-4, the predetermined time period can vary from about 5 to about 25 seconds or more. In one embodiment, the predetermined time period is 6 seconds; in another embodiment, the predetermined time period is 10 seconds. In other embodiments, the predetermined time period may vary. Alternatively, the operator can press and hold the propel enable switch 60 until the cold planer 10 is moved before releasing the propel enable switch 60.

The grade/slope system is designed to raise and/or lower the struts 18, 20 (FIG. 1) in response to obstacles on or deviations in the surface 24. The grade/slope system may be switched between automatic and manual modes via the grade/slope auto/manual switch 62. When the grade/slope auto/manual switch 62 is switched between the auto and manual modes or, if the switch 62 is in the manual mode and the grade/slope manual adjustment mechanism 64 is changed, the controller 44 may initiate a timer for a predetermined period of time, such as 10 seconds. Again, this predetermined time period may vary from about 5 to about 25 seconds. If the controller 44 does not detect movement of the cold planer 10 by way of the movement sensor 56 after the predetermined time period (e.g. 10 seconds) has elapsed, the controller may send a signal to the engine to reduce the engine speed to the elevated idle speed S2. The elevated idle speed S2 may be greater than or equal to S1.

Similarly, in preparing to road the cold planer 10, if the operator lowers the cold planer 10 by changing the manual height adjustment mechanism 66, the controller 44 may also activate the timer 48 for the predetermined time period, such as 10 seconds. If movement of the cold planer 10 is not sensed by the movement sensor 56 or the controller 44 within the predetermined time period, the controller 44 may send a signal to the engine 26 causing the engine 26 to operate at the elevated idle speed S2. Otherwise, the operator can press the propel enable button 60 which will cause the controller 44 to run the engine at S3 or the last operating speed S3, S4 or S5. There is no separate milling and travel modes. Both milling operations and travel or roading operations may be carried out using the same algorithms as shown in FIGS. 3-5.

FIGS. 3 and 4 illustrate the control scheme programmed into the memory 46 of the controller 44 in detail. First, the engine and system are started at 100 and the controller 44 determines whether the rotor speed control switch 58 is in an on position at 101. If the rotor speed control switch 58 is not in the on position, but is in a neutral or off position, the system may revert back to the start mode at 100 and checks whether the rotor speed control switch is on at 101 repeatedly until the operator activates the rotor speed control switch 58. When the rotor speed control switch 58 is activated at 101 by the operator, the controller 44 may send a signal to the engine 26 to set the operating speed at the low idle speed of S1 at 102. The controller then checks whether the engine is operating at the low idle speed S1 at 103 and, if a speed adjustment needs to be made, the system loops back to the step 102 and sets the engine speed to S1. When the engine speed is at S1, or the low idle speed, the controller sends a signal to the clutch 50 to engage the rotor 21 at 104. Engagement between the rotor and clutch is confirmed at 105 and, when the rotor 21 and clutch 50 are engaged, the controller 44 sends a signal to the engine 26 to set the engine speed to the elevated idle speed S2 at 106. Confirmation that the engine 26 is operating at S2 is confirmed at 107.

S1, the low idle speed, and S2, the elevated idle speed, are selected based upon the specific cold planer 10 design and the size of the engine 26. By way of example only, one suitable engine speed for the low idle S1 may be 1000 rpm, although S1 may vary from about 800 to about 1100 rpm, and S2 is greater than or equal to S1. S2 may therefore vary from about 800 to about 1350 rpm. One suitable engine speed for the elevated idle S2 may be 1150 rpm. Of course, these values may vary greatly depending upon the size of the engine 26 and the size and type of the cold planer 10.

Once the engine speed is set at S2, a variety of different operator inputs may cause the controller 44 to activate the timer 48 for the predetermined time period, e.g., about 10 seconds, and to set the engine speed to the last operating speed before the rotor speed control switch 58 is turned off. The purpose of the timer 48 is to ensure that the cold planer 10 begins to move after one of the operator inputs is received. Specifically, after the engine speed is raised to S2 at 106, 107, the controller will check to determine whether the propel enable switch 60 is on at 108. Once the propel enable switch 60 is turned to the on position (see FIG. 2), the controller will start the timer at 109, set the engine speed to the last operating speed, and check to determine whether movement of the cold planer 10 has been initiated at 110. If movement of the cold planer 10 has not been initiated at 110, and the predetermined time period has elapsed at 111, the system reverts back to either steps 106 or 107 and the engine speed is reduced to S2. Similarly, if the cold planer 10 is lowered manually at 112, the timer is started by the controller 44 at 113 and the controller 44 checks for movement at 114 and, if no movement is detected within the predetermined time period, e.g. ten seconds, 115, the machine may be optionally raised at 116 before the system reverts back to 106 where the speed of the engine 26 is reset to the elevated idle speed, S2.

If the grade/slope system is set to auto by way of the switch 62 on the control console 42 at 117, the controller 44 starts the timer at 118 and checks for movement at 119. If no movement is detected by the end of the predetermined time period at 120, the controller 44 reverts the system back to 106 and resets the engine speed at S2. Similarly, if the grade/slope setting is changed by way of the controlled mechanism 64 on the control console 42 at 121, the timer is started at 122 and the controller 44 checks for movement of the cold planer 10 at 123. If no movement is detected by the end of the elapsed time period at 124, the system reverts back to step 106 and the speed of the engine 26 is reset to S2. Also, if the operator stops the cold planer 10 or for another reason, the cold planer 10 is stopped or its motion is ceased at 125, the timer is started at 126 and the controller 44 checks for movement at 127. If no movement is detected after the predetermined time period has elapsed at 128, the controller sends a signal to the engine to revert to the elevated idle speed S2, or the system returns to step 106 as shown.

The operator is free to use the rotor speed control switch 60 to change the engine speed at any time. The speed chosen by the operator is shown on the display 60 and the engine 26 will operate at that speed after the propel enable switch is pressed at 108, the cold planer 10 is lowered at 112, the grade/slope auto/manual switch 62 is switched from manual to auto mode, the grade/slope value is adjusted via the grade/slope mechanism 64 while the grade/slope auto/manual switch is in auto mode, or when the cold planer 10 is manually lowered, e.g., by lowering the cold planer 10 using the height adjustment mechanism 66.

Still referring to FIG. 3, if movement is detected at 110 after the propel enable switch 60 is turned on at 108, the system checks the position of the rotor speed control switch 58 to determine which operating speed (S3, S4 or S5) the operator has selected. Thus, after movement has been detected by the controller at 110, the controller then determines whether the rotor speed control switch has been pressed once at step 200. If the rotor speed control switch 58 has been pressed once, the engine speed is set to S3 at 201 from the previous operating speed. If the rotor speed control switch 58 is pressed again at 202, the controller 44 sends a signal to the engine 26 to set the engine speed to S4 at 203 from the previous operating speed. If, however, at step 200, the controller determines that the rotor speed control switch 58 has been pressed twice at 204, the engine speed is set to S4 at 205 from the previous operating speed and, if the operator presses the rotor speed control switch 58 another time at 206, the controller 44 sets the speed of the engine 26 to S5 at 207 from the previous operating speed. If the controller 44 determines that the rotor speed control switch has been pressed three times at 208, the controller 44 sets the engine speed to S5 at 209 from the previous operating speed. Once the max speed of S5 has been reached, if the operator presses the rotor speed control switch 58 another time at 210, the controller sets the engine speed back to S3 at 211 from the previous operating speed. However, the system may be designed to set the speed of the engine to S4 at step 211 as well.

It will be noted that speed control for milling operations is the same as for roading or travel operations. That is, there is no separate travel and milling modes. To travel, the operator merely raises the cold planer 10 to a suitable height using the height adjust knob 66 followed by pressing or activating the propel enable switch 60, which will cause the controller 44 to run the engine 26 at S3 or the last operating speed S3, S4 or S5.

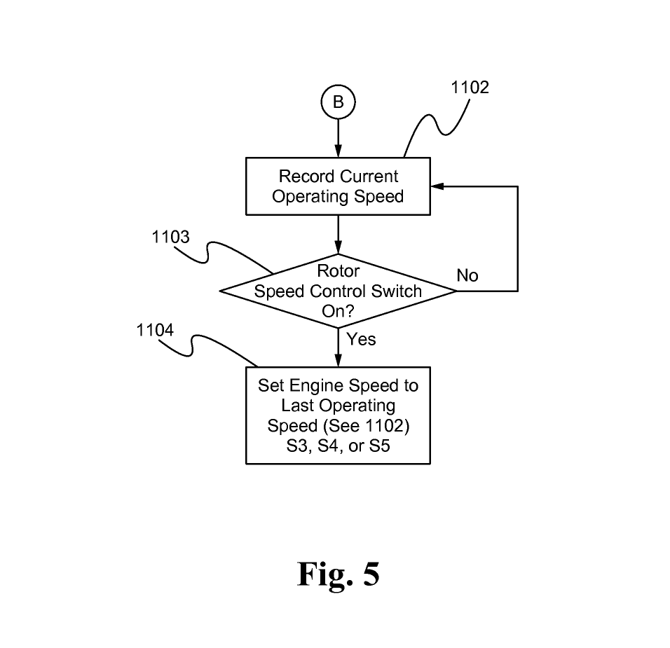

FIG. 5 illustrates, schematically, the return of the engine speed to the previous operating speed, unless the operator intervenes by toggling the rotor speed control switch 58. When the rotor speed control switch 58 is toggled to the on/switch position (see FIG. 3) at 101 and then is subsequently turned off at 1101, the current operating speed is recorded at 1102 and when the rotor speed control switch is toggled on again at 1103, the engine speed is set to the last operating speed at 1104.

Of course, the variables discussed above may be changed based upon machine requirements. The purpose of the described control system is two-fold. First, cold planers 10 can consume large quantities of fuel and reducing the speed of the engine 26 between movements of the cold planer 10, especially if the delay between movements is greater than a predetermined time period, e.g. 5 seconds, 6 seconds, 10 seconds, 20 seconds, 30 seconds, etc., fuel is saved by lowering the engine speed to the elevated idle speed S2 without substantially compromising the speed of the milling operation. S2 is greater than or equal to S1, which may be the lowest operating speed of the engine 26. The operator can then reestablish the desired operating speed, S3, S4 or S5, by pressing the rotor speed control switch 58 the desired number of times.

The second benefit provided by the disclosed control system is saving wear and tear on the clutch 50. Specifically, the clutch 50 remains engaged with the rotor 21 while the engine 26 is operating at the elevated idle speed S2. The reader will note that if no movement of the cold planer 10 is detected after a predetermined time period following five different operator input actions shown at 108, 112, 117, 121 and 125, the speed of the engine 26 is lower to the elevated idle speed S2. Thus, the clutch 50 remains engaged with the rotor 21. Disengagement of the clutch only comes after a complete shut down, upon initiation by the operator.

A third benefit is the use of a single control mode for both milling and travel operations. The operator does not need to know or remember what mode he/she is in. There is preferably only a single speed control that is used for milling and roading.

Further, it will be noted that the number of operating speeds in the above example is just three, S3, S4 and S5. However, the number of operating speed may vary greatly, depending upon the machine and working conditions. For example, anywhere from two to eight different operating speeds may also be desirable.

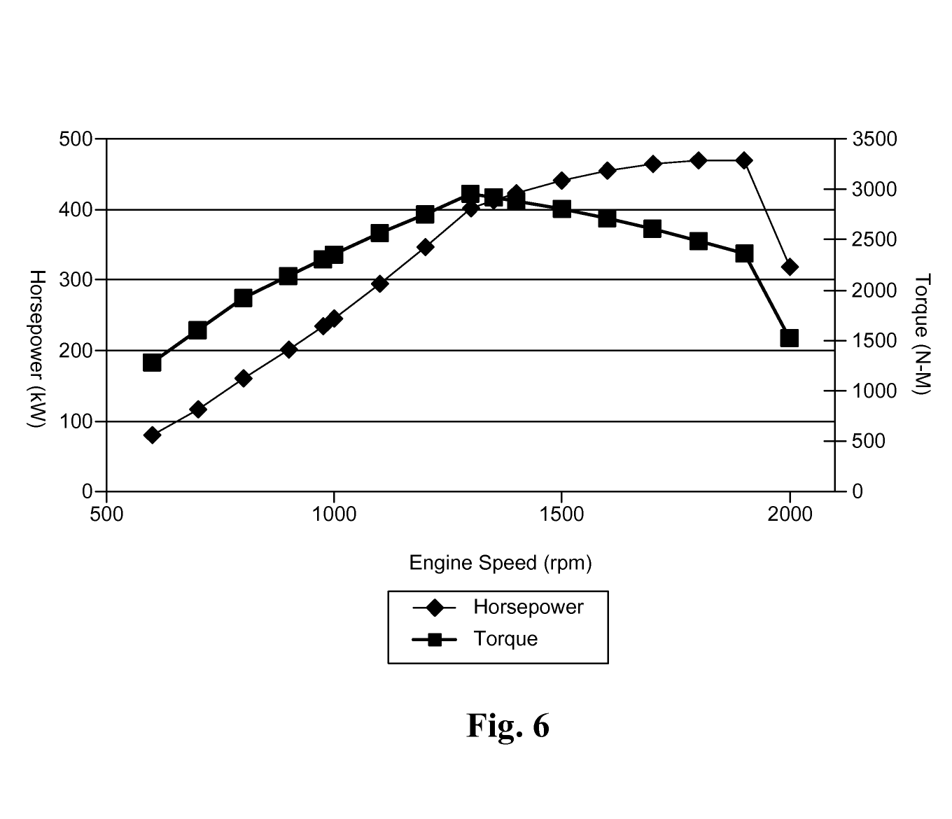

FIG. 6 is a torque map for an exemplary cold planer 10 that illustrates the suitability of the cutting speeds S3 (1500-1800 rpm), S4 (1650-1950 rpm) and S5 (1800-2100 rpm). Specifically, if the rotor 21 engages a hard object while cutting or milling, the speed of the engine 26 and rotor 21 declines. Referring to the left side of FIG. 5, reducing engine speeds below about 1300 rpm results in a decrease in torque. However, if operating at 1900, 1750 or 1600 rpm, or speeds between those values, a reduction in the engine speed results in an increase in torque as shown on the right side of the graph, which is desirable when the cold planer 10 is asked to cut or mill through a hard object.

### INDUSTRIAL APPLICABILITY

In operation, the operator will engage the rotor 21 by pressing the rotor speed control switch 58 on the control console 42. The rotor speed control switch 58 may be a momentary two position switch, a rocker switch or a toggle switch, and the default position may be a center position of the switch 58 as illustrated in FIG. 2. One position of the rotor speed control switch 58 may be dedicated to turning the rotor 21 off while the other position may be dedicated for engaging the rotor 21 and cycling through the different operating speeds S3, S4, S5.

The rotor 21 is engaged by pressing the rotor speed control switch 58 in the on direction as illustrated in FIG. 2. When the rotor 21 is engaged, the desired speed of the engine 26 will be a low idle speed 51 which, for example, may be about 1000 rpm. An initial pressing of the rotor speed control switch 58 automatically causes the controller 44 to direct the engine 26 to run at 51 regardless of any other commands being given. An initial engagement of the rotor may override all other timers, machine commands, etc. The low idle speed S1 is preferably chosen to preserve the life of the clutch 50 and to conserve fuel. For some cold planers 10, a low idle speed of 1000 rpm provides extended clutch life whenever the clutch 50 engages the rotor 21. Once the engine 26 reaches the low idle speed of S1, the rotor 21 will engage the clutch 50. After the rotor 21 has engaged the clutch 50, the speed of the engine 26 will automatically proceed to the elevated idle speed of S2. For at least some cold planers, a elevated idle speed S2 of 1150 rpm is satisfactory as fuel consumption is low and the transition to the higher milling speeds S3, S4, S5 is relatively easy.

The operator will be able to select between a plurality of milling speeds S3, S4, S5. For at least some cold planers, suitable low, medium and high milling speeds of 1500-1800 rpm (e.g., 1600 rpm), 1650-1950 rpm (e.g., 1750 rpm) and 1800-2100 rpm (e.g., 1900 rpm) will be satisfactory. The number of different cutting/milling speeds and the actual engine speeds used for the cutting/milling will vary from cold planer to cold planer as will be apparent to those skilled in the art. The speed of the engine 26 is selected by pressing the rotor speed control switch 58 in the on/cycle direction once for S3, twice for S4 and three times for S5 as generally illustrated in FIG. 4. If the rotor speed control switch 58 is pressed again after the high speed of S5 is reached, the desired speed will go to S3. Indicators, such as the display 60, may be placed on the control console 42 to tell the operator what the current speed setting is. The speed of the engine 26 may remain at the elevated idle speed S2 as the operator cycles through the settings via the rotor speed control switch 58 while the cold planer 10 is stationary.

The speed of the engine 26 will elevate to the desired setting once the speed of the engine 26 reaches the elevated idle speed S2. After the engine 26 reaches the speed S2 or a higher speed, a plurality of operator inputs can initiate the activation of the timer 48 so the controller 44 can determine that the cold planer 10 is indeed moving within the predetermined time period. As explained above, the predetermined time period can be relatively short, such as five, six or 10 seconds long or may be extended to a longer time period such as 15 or 20 seconds or longer. Ten seconds has proven to be a satisfactory time period for at least some embodiments. However, the predetermined time period may range from about 5 to about 25 seconds, more typically, from about 5 to about 15 seconds.

For example, when the propel enable switch 60 is pressed to the on position, the operator has the predetermined time period within which to start moving the cold planer 10. If movement is not detected by the controller 44 within the predetermined time period, the speed of the engine 26 is reduced to S2. The operator will have to press the propel enable switch 60 again to re-enable movement of the cold planer 10.

If the operator adjusts height of the cold planer 10, via the height adjustment mechanism 66, the timer is started and if movement is not initiated before the end of the predetermined time period, the controller 44 sends a signal to the engine 26 to lower the engine speed to S2. Similarly, if the grade and slope system is set to auto mode via the switch 62, the timer will start and the operator has the predetermined time period within which to start movement of the cold planer 10 or the controller 44 will send a signal to the engine 26 to reduce the engine speed to S2. Further, if a setting in the grade and slope system is changed, such as a manual adjustment via the grade/slope manual slope manual adjustment mechanism 64, the timer 48 will be activated and the operator has the predetermined time period within which to initiate movement of the cold planer 10. Also, if the operator stops the cold planer 10 or if the cold planer 10 stops for some other reason, the timer 48 will be activated and the controller will communicate with the engine to reduce the engine speed to S2 if movement is not reinitiated within the predetermined time period.

Essentially, any time a new command is given, the timer 48 will be activated. When the cold planer 10 is propelling forward with the rotor 21 activated, it is assumed that the cold planer 10 is milling (although in some instances it may not be) and the speed of the engine 26 will remain at the desired speed, S3, S4, S5 . . . The timer 48 need not be activated when the cold planer 10 is moving.

A benefit of automatically lowering the speed of the engine 26 is reduced fuel consumption and reduced noise levels. The timer 48 effectively limits the cycling from the elevated idle speed S2 to the higher S3, S4 or S5 milling speeds. If the desired cutting speed is changed while the speed of the engine 26 is elevated, i.e. before the timer expires or while propelling forward with the rotor 21 activated, the actual desired speed may change to the new setting immediately. When the cold planer 10 is propelling in a reverse direction, it may be assumed that a cold planer 10 is not milling and the speed of the engine 26 will follow the desired speed based upon the propel system engine speed map, not the set S3, S4 or S5 milling speed.

To turn the rotor off, the operator will press the rotor speed control switch 58 in the off direction. The clutch 50 will automatically disengage from the rotor 21 and the speed of the engine 26 may drop to the S1 speed or a lower speed. For example, the engine speed may drop to 800 rpm or the lowest engine speed based upon the other machine commands being performed. In an embodiment, S1 may be the lowest engine speed.

What is claimed is:

1. A cold planer comprising:
an engine coupled to a clutch, the clutch detachably engaged with a rotor, the engine and clutch being linked to a controller,
the controller also linked to a control console, the control console including a plurality of operator inputs, the plurality of operator inputs including a rotor speed control switch, a propel enable switch and a height adjust mechanism, the rotor speed control switch having at least an off position, an on position and a plurality of different engine speed positions, the propel enable switch sending a signal to the controller to allow the cold planer to move, the height adjust mechanism for raising the cold planer for roading and lowering the cold planer for milling,
wherein, for both milling and roading, the controller is programmed to adjust the engine speed to a first speed when the engine is running, the rotor speed control switch is switched to the on position and the clutch is not engaged with the rotor,
wherein, for both milling and roading, the controller is programmed to send a signal to the clutch to engage the rotor when the engine reaches the first speed,
wherein, for both milling and roading, the controller is also programmed to adjust the engine speed from the first speed to a second speed that is equal to or higher than the first speed when the engine is running at the first speed and after the controller has sent a signal to the clutch causing the clutch to engage the rotor,
wherein, for both milling and roading, the controller is also programmed to adjust the engine speed from the second speed to a higher speed equal to a last operating speed of the cold planer,
upon activation of the propel enable switch, the timer is activated and, if a predetermined time period has elapsed without movement of the cold planer, the controller is programmed to run the engine at the second speed.

2. The cold planer of claim 1 wherein the controller also programmed to adjust the engine speed to one of a third, fourth or fifth speeds when the rotor speed control switch is switched to said one of the third, fourth or fifth speeds.

3. The cold planer of claim 2 wherein the engine speed may be changed using the rotor speed control switch at any time during the operation of the cold planer.

4. The cold planer of claim 1 wherein the plurality of different engine speed positions of the rotor speed control switch are accessed by switching the rotor speed control switch to the on position while the engine is running and the clutch is engaged with the rotor.

5. The cold planer of claim 1 wherein the rotor speed control switch is a toggle switch having the off position, the on position and a neutral position, the toggle switch being biased towards the neutral position, the plurality of speed positions are accessed by repeatedly toggling the rotor speed control switch to the on position.

6. The cold planer of claim 1 wherein the rotor speed control switch commands the controller to run the engine at either the first speed, the second speed, a third speed that is higher than the second speed, a fourth speed that is higher than the third speed or a fifth speed that is higher than the fourth speed, and
the rotor speed control switch is a toggle switch having the off position which sends a signal to the controller to reduce the engine speed to the first position, the on position which sends a signal to the controller to run the engine speed at the third, fourth or fifth speed positions when the rotor speed control switch is toggled to the on position after the clutch has engaged the rotor and the engine is running at the second speed or one of the third, fourth and fifth speeds.

7. The cold planer of claim 6 wherein, if the engine is running at the fifth speed, and the rotor speed control switch is toggled to the on position, the rotor speed control switch will send a signal to the controller to run the engine at the third speed.

8. The cold planer of claim 1 wherein the first speed is a low idle with the clutch disengaged from the rotor and the second speed is an elevated idle with the clutch engaged with the rotor.

9. The cold planer of claim 1 wherein the controller is programmed to run the engine at the second speed or a higher speed when the clutch has engaged the rotor.

10. The cold planer of claim 1 wherein, if the propel enable switch is activated and the predetermined time period elapses without movement of the cold planer, the controller runs the engine at the second speed until the propel enable switch is activated a second time.

11. The cold planer of claim 1 further including a height adjustment mechanism that enables manual adjustment of a height of the cold planer above a work surface,
wherein, upon changing the height of the cold planer above the work surface, the timer is activated and, if a predetermined time period has elapsed without movement of the cold planer, the controller is programmed to run the engine at the second speed.

12. The cold planer of claim 1 further including four track assemblies that support the cold planer above a work surface, each track assembly is coupled to the cold planer by an adjustable rod, the cold planer further includes a grade/slope adjustment mechanism that includes an automatic mode that enables automatic adjustment of the rods of the track assemblies and a manual mode that enables manual adjustment of the rods of the track assemblies,
wherein, when the grade/slope adjustment mechanism is switched to the automatic mode, the timer is activated and, if a predetermined time period has elapsed without movement of the cold planer, the controller is programmed to run the engine at the second speed.

13. The cold planer of claim 1 further including four track assemblies that support the cold planer above a work surface, each track assembly coupled to the cold planer by an adjustable rod, the cold planer further including a grade/slope adjustment mechanism includes an automatic mode that enables automatic adjustment of the rods of the track assemblies and a manual mode that enables manual adjustment of the rods of the track assemblies,
wherein, when one or more of the following occurs: the grade/slope adjustment mechanism is switched to the automatic mode from the manual mode; an adjustment is made to the grade/slope while in automatic mode; or an adjustment to the height of the cold planer is made in the manual mode, the timer is activated and, if a predetermined time period has elapsed without movement of the cold planer, the controller is programmed to run the engine at the second speed.

14. The cold planer of claim 1, wherein, if the cold planer stops moving and if a predetermined time period has elapsed without movement of the cold planer, the controller is programmed to run the engine at the second speed.

15. A method of controlling a speed of an engine and a rotor of a cold planer, the method comprising:
providing the cold planer with an engine coupled to a clutch, the clutch detachably engaged with a rotor, the engine and clutch being linked to a controller, the controller also linked to a control console and a timer, the control console including a plurality of operator inputs, the plurality of operator inputs including a rotor speed control switch, a height adjustment mechanism and a propel enable switch, the rotor speed control switch having at least an off position and an on position,
adjusting the height of the cold planer above a work surface for a milling operation or a roading operation,
adjusting the engine speed to a first speed when the engine is running and the rotor speed control switch is switched to an on position and the clutch is not engaged with the rotor,
engaging the rotor with the clutch when the engine reaches the first speed,
adjusting the engine speed from the first speed to a second speed after the clutch has engaged the rotor,
adjusting the engine speed from the second speed to a higher speed equal to a last operating speed of the cold planer,
upon activation of the propel enable switch, activating the timer and, if a predetermined time period elapses without movement of the cold planer, adjusting the engine speed to the second speed.

16. The method of claim 15 wherein, upon changing the height of the cold planer above the work surface, activating the timer and, if a predetermined time period has elapsed without movement of the cold planer, adjusting engine speed to the second speed.

17. The method of claim 15 wherein the cold planer further includes four track assemblies that support the cold planer above a work surface, each track assembly is coupled to the cold planer by an adjustable rod, the cold planer further includes a grade/slope adjustment mechanism that includes an automatic mode that enables automatic adjustment of the rods of the track assemblies and a manual mode that enables manual adjustment of the rods of the track assemblies,
wherein, when the grade/slope adjustment mechanism is switched to the automatic mode, activating the timer and, if a predetermined time period has elapsed without movement of the cold planer, adjusting the engine speed to the second speed.

18. The method of claim 15 wherein the cold planer further includes four track assemblies that support the cold planer above a work surface, each track assembly coupled to the cold planer by an adjustable rod, the cold planer further including a grade/slope adjustment mechanism includes an automatic mode that enables automatic adjustment of the rods of the track assemblies and a manual mode that enables manual adjustment of the rods of the track assemblies,
wherein, when one or more of the following occurs: the grade/slope adjustment mechanism is switched to the automatic mode from the manual mode; an adjustment is made to the grade/slope while in automatic mode; or an adjustment to the height of the cold planer is made in the manual mode, the timer is activated and, if a predetermined time period has elapsed without movement of the cold planer, the controller is programmed to run the engine at the second speed.

19. The method of claim 1, wherein, when the cold planer is moving and the clutch has engaged the rotor, and if the controller stops sending signals to the engine to run at the third speed or faster, the method further includes activating the timer and, if a predetermined time period has elapsed without movement of the cold planer, adjusting the engine speed to the second speed.

20. A cold planer comprising:
an engine coupled to a clutch, the clutch detachably engaged with a rotor,
the engine and clutch being linked to a controller,
the controller also linked to a control console, the control console including a plurality of operator inputs including a rotor speed control switch, a height adjustment mechanism and a propel enable switch, the cold planer further including a timer, the rotor speed control switch being a toggle switch and having an off position, an on position and a neutral position, the rotor speed control switch being able to access a plurality of different engine speeds by toggling the rotor speed control switch repeatedly to the on position, the height adjust mechanism for raising the cold planer for roading and lowering the cold planer for milling,
wherein, for both milling and roading, the controller is programmed to adjust the engine speed to a first speed when the engine is running and the rotor speed control switch is switched to the on position and the clutch is not engaged with the rotor,
wherein, for both milling and roading, the controller is programmed to send a signal to the clutch to engage the rotor when the engine reaches the first speed,
wherein, for both milling and roading, the controller is also programmed to adjust the engine speed from the first speed to a second speed that is greater than or equal to the first speed when the engine is running at the first speed and after the controller has sent a signal to the clutch causing the clutch to engage the rotor,
wherein, for both milling and roading, the controller is also programmed to adjust the engine speed from the second speed to a last operating speed of the cold planer when the rotor speed control switch is toggled to the on position when the engine is running at the second speed,
the first speed being a low idle speed for engaging the clutch, the second speed being an elevated idle speed while the clutch is engaged and the operating speeds including at least a third speed being a low cutting speed, the rotor speed control switch also providing access to higher cutting speeds than the third speed,
upon activation of one of the operator inputs selected from the group consisting of activating the propel enable switch, changing a height of the cold planer above a work surface, changing a setting of the grade/slope system, stopping the cold planer and combinations thereof, the timer is activated and, if a predetermined time period has elapsed without movement of the cold planer, the controller is programmed to run the engine at the second speed.
